(19) United States
(12) Patent Application Publication
(10) Pub. No.: US 2009/0031386 A1
(43) Pub. Date: Jan. 29, 2009

(54) Multi-Antenna Digital Television Box and the Receiving Method Thereof

(75) Inventor: Chun-Kai Chan, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTek Computer Inc., Taipei (TW)

(21) Appl. No.: 12/170,467

(22) Filed: Jul. 10, 2008

(30) Foreign Application Priority Data
Jul. 24, 2007 (TW) 96126990

(51) Int. Cl. H04N 7/173

(52) U.S. Cl. 725/131

(57) ABSTRACT

A multi-antenna digital television box includes a plurality of receiving antennas, a comparator connected to the receiving antennas and a digital television chip. Each receiving antenna has a receiving signal. The comparator may be used to compare the receiving signals and select a stronger receiving signal from the receiving signals. The stronger receiving signal may be inputted to the digital television chip to be converted to an audio and video signal to output. A receiving method of the multi-antenna digital television box is also disclosed.

### RELATED APPLICATIONS

This application claims priority to Taiwan Application Serial Number 96126990, filed Jul. 24, 2007, which is herein incorporated by reference.

### BACKGROUND OF THE INVENTION

1. Field of the Invention

The invention relates to a digital television box and, more particularly, to a multi-antenna digital television box.

2. Description of the Related Art

Since the digital television provides pictures with high quality and has large capacity and many interactive functions, it is very hot in the digital times. The digital video broadcasting (DVB) established by Europe Broadcasting Union, advanced television systems committee (ATSC) of United States and integrated services digital broadcasting (ISDB) of Japan are the main standards relating to the digital television in the world.

The digital television box is a device mainly used to convert the analog signals to the digital signals and further convert the digital signals to the signals with the display format. With the popularity of digital television, the digital television box also may directly receive the signals of a digital television and convert the digital signals to the signals with the display format.

For the digital television, the manner of receiving signals is using a single antenna to receive signals and transmit the signals to the digital television chip to process or using two groups of antennas to transmit signals to a diversity chip to perform the diversity combining. However, the strength of the signals received by the digital television antenna changes with the different location and different time.

### BRIEF SUMMARY OF THE INVENTION

The objective of the invention is to provide a multi-antenna digital television box and the receiving method thereof used for improving the output quality of the digital television box.

According to a preferred embodiment of the invention, a multi-antenna digital television box is provided. The multi-antenna digital television box includes a plurality of receiving antennas, a comparator connected to the receiving antennas and a digital television chip. Each of the receiving antennas receives a receiving signal, respectively. The comparator may be used to compare the receiving signals and select a stronger receiving signal which may be inputted to the digital television chip to be converted to an audio and video signal to output. The comparator may compare signal strength values of the receiving signals. The stronger receiving signal has a stronger signal strength value. The comparator may compare bit error rates (BER) of the receiving signals. The stronger receiving signal has a less BER. Each receiving antenna further has a tuner.

The invention further provides a multi-antenna digital television box including a plurality of receiving antennas, a comparator connected to the receiving antennas and a digital television chip. Each receiving antenna receives a receiving signal. The comparator is used to compare the receiving signals and select two stronger receiving signals. The digital television chip has a master input end and a slave input end. The stronger receiving signals are inputted to the master input end and the slave input end, respectively. A diversity combining may be performed on the stronger receiving signals to obtain a diversity signal which is converted to be an audio and video signal to output. The two stronger receiving signals include a strongest receiving signal and a next strongest receiving signal. The strongest receiving signal is preferred to be inputted to the master input end, and the next strongest receiving signal is preferred to be inputted to the slave input end. The comparator may compare signal strength values of the receiving signals. The stronger receiving signal has a stronger signal strength value. The comparator compares BERs of the receiving signals. The stronger receiving signal has a less BER. Each receiving antenna may further have a tuner.

In the invention, the comparator is utilized to select one or two receiving signals from the receiving signals of a plurality of receiving antennas to be the signal source of the digital television chip. Thus, the output quality of the multi-antenna digital television box is effectively assured. If the digital television chip is a diversity chip, the strongest receiving signal and the next strongest receiving signal of the stronger receiving signal may be inputted into the master input end and the slave input end, respectively.

These and other features, aspects, and advantages of the present invention will become better understood with regard to the following description, appended claims, and accompanying drawings.

### BRIEF DESCRIPTION OF THE DRAWINGS

FIG. 1 is a block diagram showing a multi-antenna digital television box of a preferred embodiment of the invention;

FIG. 2 is a block diagram showing a multi-antenna digital television box of another preferred embodiment of the invention; and

FIG. 3 is a flow chart showing a receiving method of a multi-antenna digital television box of a preferred embodiment of the invention.

### DETAILED DESCRIPTION OF THE EMBODIMENTS

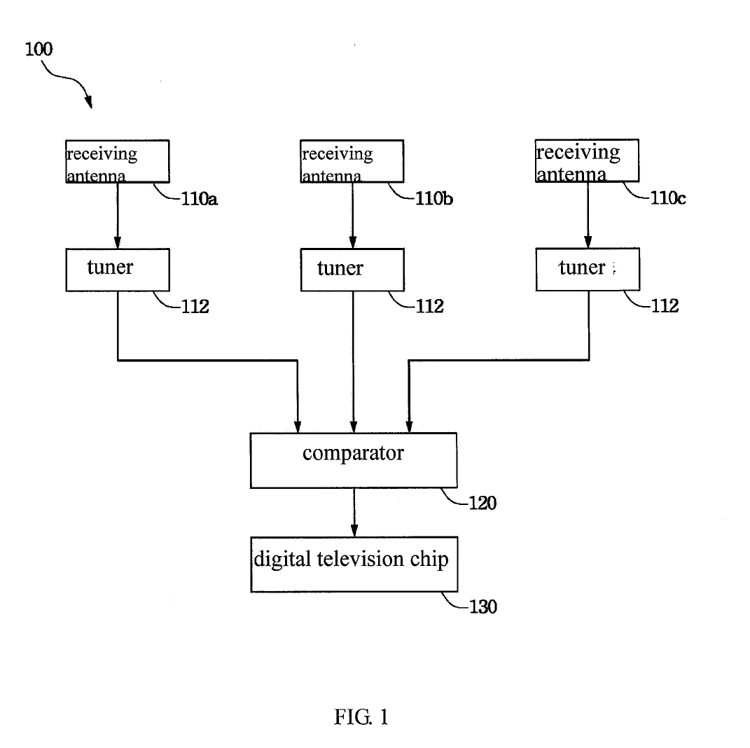

FIG. 1 is a block diagram showing a multi-antenna digital television box of a preferred embodiment of the invention. The multi-antenna digital television box 100 includes a plurality of receiving antennas 110a, 110b and 110c, a comparator 120 and a digital television chip 130. The receiving antenna 110a, 110b and 110c may be provided at different locations, wherein each of the receiving antennas 110a, 110b and 110c has a receiving signal. The comparator 120 compares the receiving signals of the receiving antennas 110a, 110b and 110c and selects a stronger receiving signal to input the stronger receiving signal to the digital television chip 130 to be the signal source of the digital television chip 130. The digital television chip 130 includes a decoder converting the digital signal to the audio and video signal such as a moving picture expert group (MPEG) 2 signal. The invention is not limited by the format of the audio and video signal, and other standards in the field such as MPEG 4 also may be used by the invention. In the invention, a stronger receiving signal may be selected from the receiving signals of the receiving antennas 110a, 110b and 110c to be the signal source of the digital television chip 130. Thus, the output quality of the multi-antenna digital television box 100 is assured.

The quality of the receiving signals of the receiving antennas 110a, 110b and 110c are related to the signal strength values and the bit error rates (BER) of the receiving signals. The greater the signal strength value of the receiving signal is and the less the BER is, the better the quality of the receiving signal is. Therefore, the comparator 120 may compare the signal strength values of the receiving values of the receiving antennas 110a, 110b and 110c, select a receiving signal whose signal strength value is greater and input the stronger receiving signal to the digital television chip 130 to be the signal source. The comparator 120 also may compare the BERs of the receiving signals of the receiving antennas 110a, 110b and 110c, select a receiving signal whose BER is less and input the stronger receiving signal to the digital television chip 130 to be the signal source of the digital television chip 130.

The comparator 120 may be hardware such as a programmable logic device (PLD), a field programmable gate array (FPGA), a complex programmable logic device (CPLD) and an integrated circuit chip, or the comparator 120 also may be a program built in the digital television chip 130.

Each of the receiving antennas 110a, 110b and 110c of the multi-antenna digital television box 100 has a tuner 112 to convert the received high-frequency signal to the receiving signals which may be processed. The multi-antenna digital television box 100 may be used to receive digital signals or analog signals. If the multi-antenna digital television box 100 is used to receive the analog signal, each of the receiving antennas 110a, 110b and 110c further has a demodulator to convert the analog signals to the digital signals.

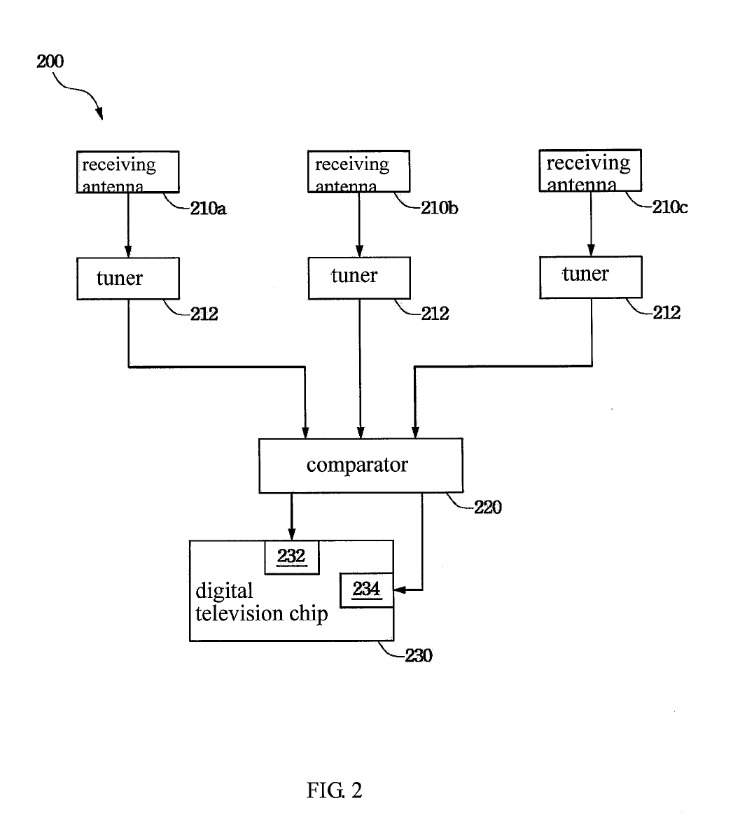

FIG. 2 is a block diagram showing a multi-antenna digital television box of another preferred embodiment of the invention. In the embodiment, the multi-antenna digital television box 200 has a plurality of receiving antennas 210a, 210b and 210c. The used digital television chip 230 is a diversity chip having a master input end 232 and a slave input end 234. Two digital signals may be inputted to the master input end 232 and the slave input end 234, respectively, to perform the diversity combining to combine the two digital signals. Thus, a diversity signal with preferred bit completeness is obtained. The digital television chip 230 includes a decoder to convert the diversity signal to the audio and video signal with the display format such as MPEG2 to output.

In the embodiment, the comparator 220 may select two stronger receiving signals from the receiving signals of the receiving antennas 210a, 210b and 210c and input the two stronger receiving signals to the master input end 232 and the slave input end 234 of the digital television chip 230, respectively. The two stronger receiving signals include a strongest receiving signal and a next strongest receiving signal. The strongest receiving signal is preferred to be inputted to the master input end 232, and the next strongest receiving signal is inputted to slave input end 234 to utilize the strongest receiving signal as the master signal source of the digital television chip 230. In this way, the output quality of the multi-antenna digital television box 200 is efficiently assured.

The comparator 220 may compare the signal strength values of the receiving signals of the receiving antennas 210a, 210b and 210c with the variety of the time, select two receiving signals whose signal strength values are greater and input the two stronger receiving signals to the master input end 232 and the slave input end 234 of the digital television chip 230, respectively, to be the signal source of the digital television chip 230. The comparator also may compare the BERs of the receiving signals of the receiving antennas 210a, 210b and 210c, select two receiving signals whose BER are less and input the two stronger receiving signals to the master input end 232 and the slave input end 234 of the digital television chip 230 to be the signal source of the digital television chip 230. The strongest receiving signal of the two stronger receiving signals is inputted to the master input end 232, and the next strongest receiving signal is inputted to the slave input end 234.

The comparator 220 may be hardware such as a programmable logic device (PLD), a field programmable gate array (FPGA), a complex programmable logic device (CPLD) and an integrated circuit chip, or the comparator 220 also may be a program built in the digital television chip 230. Each of receiving antennas 210a, 210b and 210c of the multi-antenna digital television box 200 has a tuner 212 to convert the received high-frequency signals to the receiving signals which may be processed.

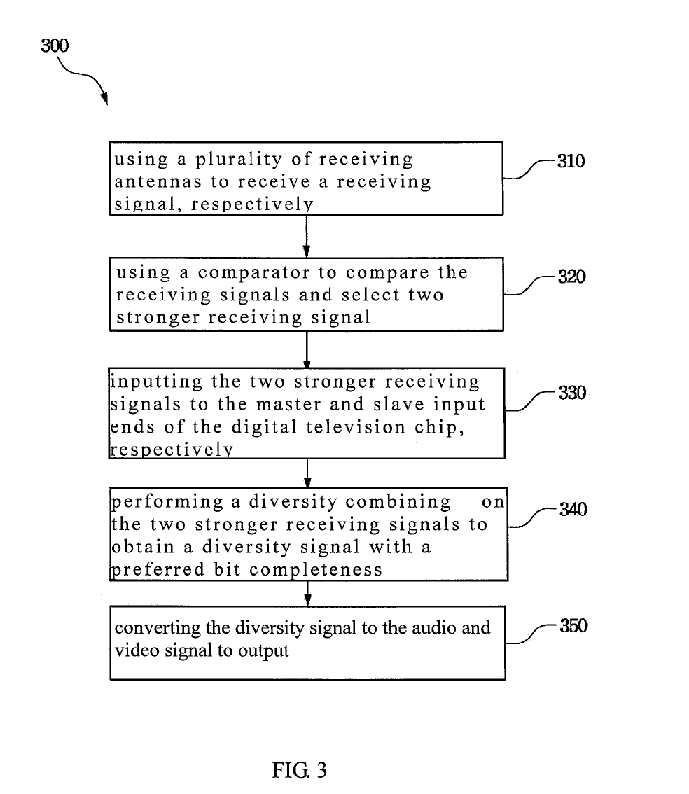

FIG. 3 is a flow chart showing the receiving method of the multi-antenna digital television box of a preferred embodiment of the invention. For the receiving method 300 of the multi-antenna digital television box, in the step 310, a plurality of receiving antennas are used to receive the receiving signals, respectively. Then, in the step 320, the comparator is used to compare the receiving signals to select two stronger receiving signals. In the step 330, two stronger receiving signals are inputted into the master input end and the slave input end of the digital television chip, respectively. In the step 340, a diversity combining is performed on the two stronger receiving signals to obtain the diversity signals with preferred bit completeness. At last, in the step 350, the diversity signal is converted to the audio and video signal to output. In the step 320, the comparator may compare the signal strength values of the receiving signals. The two stronger receiving signals have stronger signal strength values. The comparator also may compare the BERs of the receiving signals, and the two stronger receiving signals have less BERs. In the step 330, the two receiving signals may include a strongest receiving signal and a next strongest receiving signal. The strongest receiving signal is inputted into the master input end, and the next strongest receiving signal is inputted into the slave input end.

From the preferred embodiment of the invention, the invention has following advantages. In the invention, a comparator is utilized to select one or two stronger receiving signals from the receiving signals of a plurality of receiving antennas to be the signal source of the digital television chip. Thus, the output quality of the multi-antenna digital television box is assured. If the television chip is a diversity chip, the strongest receiving signal and the next strongest receiving signal of the stronger receiving signal may be inputted into the master input end and the slave input end, respectively.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A multi-antenna digital television box comprising:
a plurality of receiving antennas, each of the receiving antennas receiving a receiving signal;
a comparator connected to the receiving antennas to compare the receiving signals and select a stronger receiving signal; and
a digital television chip connected to the comparator, wherein the stronger receiving signal is inputted to the digital television chip to be converted to an audio and video signal to output.

2. The multi-antenna digital television box according to claim 1, wherein the stronger receiving signal has a stronger signal strength value.

3. The multi-antenna digital television box according to claim 1, wherein the stronger receiving signal has a less bit error rate (BER).

4. The multi-antenna digital television box according to claim 1, wherein each of the receiving antennas further correspondingly has a tuner.

5. The multi-antenna digital television box according to claim 4, wherein the receiving signal is a digital signal.

6. The multi-antenna digital television box according to claim 5, wherein each of the receiving antennas further correspondingly has a demodulator to convert an analog signal received by each of the receiving antennas to the digital signal.

7. A multi-antenna digital television box comprising:
a plurality of receiving antennas, each of the receiving antennas receiving a receiving signal;
a comparator connected to the receiving antennas to compare the receiving signals and select two stronger receiving signals; and
a digital television chip connected to the comparator and having a master input end and a slave input end,
wherein the two stronger receiving signals are inputted to the master input end and the slave input end, respectively, and a diversity combining is performed on the two stronger receiving signals to obtain a diversity signal which is converted to an audio and video signal to output.

8. The multi-antenna digital television box according to claim 7, wherein the two stronger receiving signals comprises a strongest receiving signal inputted to the master input end and a next strongest receiving signal inputted to the slave input end.

9. The multi-antenna digital television box according to claim 7, wherein each of the two stronger receiving signals has a stronger signal strength value.

10. The multi-antenna digital television box according to claim 7, wherein each of the two stronger receiving signals has a less bit error rate (BER).

11. The multi-antenna digital television box according to claim 7, wherein each of the receiving antennas further correspondingly has a turner.

12. The multi-antenna digital television box according to claim 11, wherein each of the receiving signals is a digital signal.

13. A receiving method of a multi-antenna digital television box comprising the steps of:
using a plurality of receiving antennas to receive a receiving signal, respectively;
using a comparator to compare the receiving signals and select two stronger receiving signals;
inputting the two stronger receiving signals to a master input end and a slave input end of a digital television chip, respectively; and
performing a diversity combining on the two stronger receiving signals to obtain a diversity signal which is converted to an audio and video signal to output.

14. The receiving method of the multi-antenna digital television box according to claim 13, wherein the step of using the comparator to compare the receiving signals comprises the step of comparing signal strength values of the receiving signals, and each of the two stronger receiving signals has the stronger signal strength value.

15. The receiving method of the multi-antenna digital television box according to claim 13, wherein the step of using the comparator to compare the receiving signals comprises the step of comparing bit error rates (BER) of the receiving signals, and each of the two stronger receiving signals has the less bit error rate.

16. The receiving method of the multi-antenna digital television box according to claim 13, wherein the two stronger receiving signals comprises a strongest receiving signal and a next strongest receiving signal, the strongest receiving signal is inputted to the master input end, and the next strongest signal is inputted to the slave input end.
